(19) United States
(12) Patent Application Publication
(10) Pub. No.: US 2007/0152406 A1
(43) Pub. Date: Jul. 5, 2007

(54) Width adjustable spring-loaded dovetail socket assembly

(76) Inventors: Jonathon R. Prendergast, Newport Beach, CA (US); Ronald R. Soto, Laguna Hills, CA (US)

Correspondence Address: CHRISTIE, PARKER & HALE, LLP, PO BOX 7068, PASADENA, CA, 91109-7068, US

(21) Appl. No.: 11/636,240

(22) Filed: Dec. 8, 2006

Related U.S. Application Data
(60) Provisional application No. 60/748,760, filed on Dec. 8, 2005.

(51) Int. Cl. B23B 31/40

(52) U.S. Cl. 279/2.1

(57) ABSTRACT

An adjustable socket assembly adapted to receive a night vision device, the adjustable socket assembly including a body, a branch, and guide means attached to one of the body or the branch, wherein one of the body or the branch is slidably coupled to the guide means and wherein the body is aligned with the branch to form a night vision device receiving area having an adjustable width. The guide means maintains alignment between the body and the branch. The guide means may be, for example, guide pins or retaining screws.

### CROSS-REFERENCE TO RELATED APPLICATION

This application claims priority to and the benefit of U.S. Provisional Application No. 60/748,760 filed on Dec. 8, 2005, the entire content of which is incorporated herein by reference.

### FIELD OF THE INVENTION

The present invention is directed to a width adjustable socket assembly. More specifically, the invention is directed to a socket assembly provided on a headgear mount and is adapted to receive a mounting plate from night vision goggles (NVG).

### BACKGROUND OF THE INVENTION

NVG are removably attached to a user's headgear via a headgear mount. The NVG, in one embodiment, are attached by sliding a dovetail mounting plate or insert on the NVG into a receiving socket on the headgear mount. However, even though a standardized size for dovetail plates is preferred, a variety of dovetail plate sizes are possible due to manufacturing tolerances and different manufacturers. Thus, the dovetail plate fit might range from overly tight to wobbly with the current socket assemblies, the current socket assemblies not being adjustable to accommodate the varyingly-sized dovetail plates.

An adjustable socket has been developed for goggle horns as is described in U.S. Pat. No. 6,457,179, issued on Oct. 1, 2002, the entire content of which is incorporated herein by reference. However, goggle horns require height or vertical adjustability of the socket. Dovetail plate attachments require that width or horizontal adjustability be incorporated into the socket, a form of adjustability not previously provided and more difficult to contemplate in view of the design of the sockets. As such, there is a need for a socket assembly adapted to receive a dovetail attachment, the socket assembly being width or horizontally adjustable to accommodate various dovetail attachment sizes.

### SUMMARY OF THE INVENTION

An adjustable socket assembly adapted to receive a night vision device is provided, the adjustable socket assembly including a body, a branch, and guide means attached to either the body or the branch, wherein either the body or the branch is slidably coupled to the guide means. The body is aligned with the branch to form a night vision device receiving area having an adjustable width and the guide means maintains alignment between the body and the branch. The guide means may be, for example, a plurality of guide pins or plurality of screws. The adjustable socket assembly may further include a retaining means inserted through either the body or the branch and may be attached to either the body or the branch. The retaining means, such as a retaining screw, prevent decoupling of the body and the branch from the guide means. A rail and a rail track may be included on either the body or the branch, respectively, such that when the rail track is coupled with the rail, the rail prevents the component containing the rail from decoupling from the guide means. The adjustable socket assembly may also include a coil spring inserted between the retaining member and either the body or the branch to bias the body and the branch, respectively, toward the branch or the body, respectively.

Another embodiment of adjustable socket assembly adapted to receive a night vision device is provided including a flexible frame adapted to expand when a night vision device is coupled to the adjustable socket assembly and a branch and a body attached to the frame, the branch and the body aligned to form a width adjustable night vision device receiving area. The night vision device receiving area is adapted to securely accommodate night vision devices of varying widths.

An adjustable insert to allow a night vision device to be coupled to a headgear mount is provided, the adjustable insert including a branch having a first rail, a body having a second rail, and guide means attached to either the body or the branch. At least one coil spring is inserted between the body and the branch to bias the branch away from the body and either the body or the branch is slidably coupled to the guide means. The guide means may be a plurality of guide pins. A retaining means, such as a retaining screw, may be inserted through either the branch or the body and attached to either the branch or the body to prevent the branch or the body from decoupling from the guide means. The adjustable insert may be, for example, dovetail shaped, but is not limited thereto. The adjustable insert may be attached to a height adjustable adaptor for goggle horns, by for example, an attachment screw. A roll pin may be inserted into the adjustable insert and the height adjustable adaptor, wherein the roll pin prevents rotation of the adjustable insert with respect the height adjustable adaptor.

A horizontally adjustable assembly for attaching night vision goggles to a headgear mount for night vision goggles is provided including a first member, a second member, and guide means attached to either the first member or the second member. Either the first member or the second member may be slidably attached to the guide means, and the guide means, such as a plurality of guide pins, maintain alignment between the first member and the second member.

### BRIEF DESCRIPTION OF THE DRAWINGS

FIGS. 1A-1C are an exploded view and perspective views, respectively, of one exemplary embodiment of an adjustable dovetail socket assembly of the present invention.

FIGS. 2A-2C are an exploded view and perspective views, respectively, of another exemplary embodiment of an adjustable dovetail socket assembly of the present invention.

FIGS. 3A-3C are an exploded view and perspective views, respectively, of yet another exemplary embodiment of an adjustable dovetail socket assembly of the present invention.

FIGS. 4A-4C are an exploded view and perspective views, respectively, of still another exemplary embodiment of an adjustable dovetail socket assembly of the present invention.

FIGS. 5A-5C are an exploded view and perspective views, respectively, of yet another exemplary embodiment of an adjustable dovetail socket assembly of the present invention.

FIGS. 6A and 6B are an exploded view and a perspective view, respectively, of an adjustable dovetail insert of the present invention.

FIGS. 7A and 7B are an exploded view and a perspective view, respectively, of a split adaptor having an adjustable dovetail insert.

### DETAILED DESCRIPTION

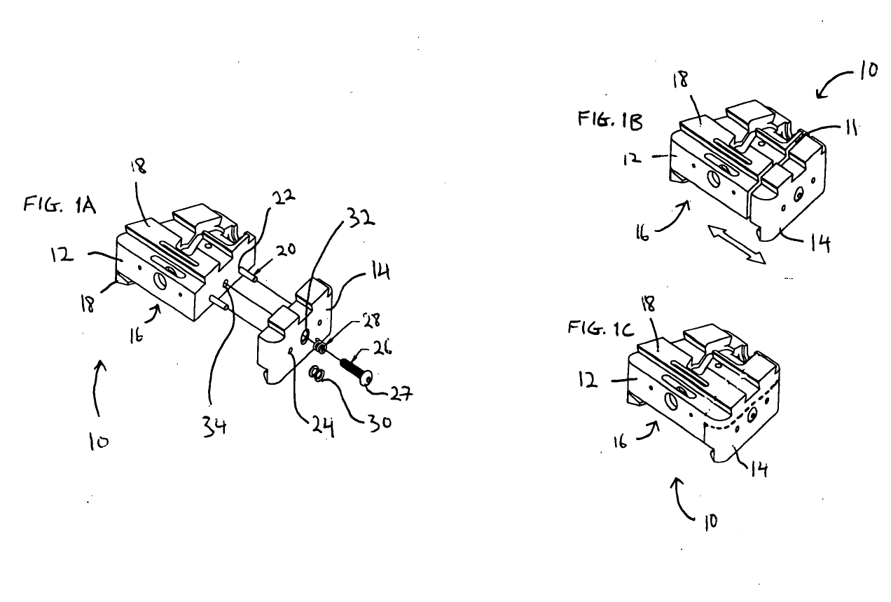

Referring now to FIGS. 1A-1C, an exemplary embodiment of a width or horizontally adjustable spring-loaded dovetail socket assembly 10 is shown. The adjustable socket assembly will self adjust to individual goggle systems and accommodate accumulated tolerances from different manufacturers and compensate for wear on mating surfaces, eliminating wobble between the helmet mount and the NVG. The adjustable socket assembly 10 includes a body 12 and side portion or a branch 14 matable with the body. The socket assembly 10 includes a dovetail receiving area 16 which is adapted to receive a dovetail insert (not shown) located on a pair of NVG. More specifically, the NVG receiving area 16 may include a lock (not shown) which snaps into a recess on the dovetail insert to secure the dovetail insert in the NVG receiving area. Additionally, the socket assembly 10 includes a pair of dovetail rails 18 which allow the socket assembly to be coupled with an NVG headgear mount, such as the headgear mount described in U.S. patent application Ser. No. 11/473,495, filed on Jun. 23, 2006, the entire content of which is incorporated herein by reference.

Referring to FIG. 1A, the body 12 and the branch 14 are coupleable by two guide pins 20. The guide pins 20 are attached to the body 12 at respective body guide pin holes 22 located on an interior lateral surface of the body. The length of the guide pins 20 may vary depending on the amount of adjustability desired for the socket assembly 10, but in one exemplary embodiment, the guide pins extend about 0.2 inch from the side of the body 12. The branch 14 has corresponding branch guide pin holes 24 on an interior lateral side, the branch guide pin holes adapted to receive the guide pins 20 from the body 12. When the guide pins 20 are inserted into the branch guide pin holes 24, thus combining the body 12 and the branch 14 into the adjustable socket assembly 10, the guide pins maintain alignment between the body and the branch. The 14 branch is slidable along the guide pins 20 with respect to the body. In this configuration, by sliding the branch 14 along the guide pins 20, a gap 11 (FIG. 1B) may be created between the body 12 and the branch 14, thus allowing for the size of the NVG receiving area 16 to be adjustable to securely accommodate dovetail inserts of various sizes. The size of the gap 11 may be dictated, among other things, by the length of the guide pins 20. In one exemplary embodiment, a maximum gap between the body 12 and the branch 14 of about 0.030 inch may be created. However, the size of the gap is not limited thereto, and as will be understood by one skilled in the art, wider gaps may be created.

To maintain the attachment between the body 12 and the branch 14, a retaining screw 26 may be inserted through a branch retaining hole 32 and threaded into a body threaded hole 34 adapted to receiving the retaining screw. A head 27 of the screw prevents the branch 14 from sliding off an end of the guide pins 20, thus preventing complete separation of the branch from the body 12. The limit of the width of the gap 11 may be determined by the depth to which the retaining screw 26 is threaded into the body threaded hole 34. For example, the farther the screw is threaded into the body threaded hole 34, the narrower the gap 11 between the body 12 and the branch 14 can be at its widest extent. A coil spring 28 may be inserted between the head of the retaining screw 26 and a side of the branch 14 to pre-load the socket assembly. Thus, when a dovetail insert is inserted into the NVG receiving area 16, the coil spring 28 biases the branch 14 against the dovetail insert to allow the socket assembly 10 to securely retain the dovetail insert. In an alternate embodiment, belville washers 30 may be placed between the branch side and the head of the retaining screw 26 to pre-load the socket assembly.

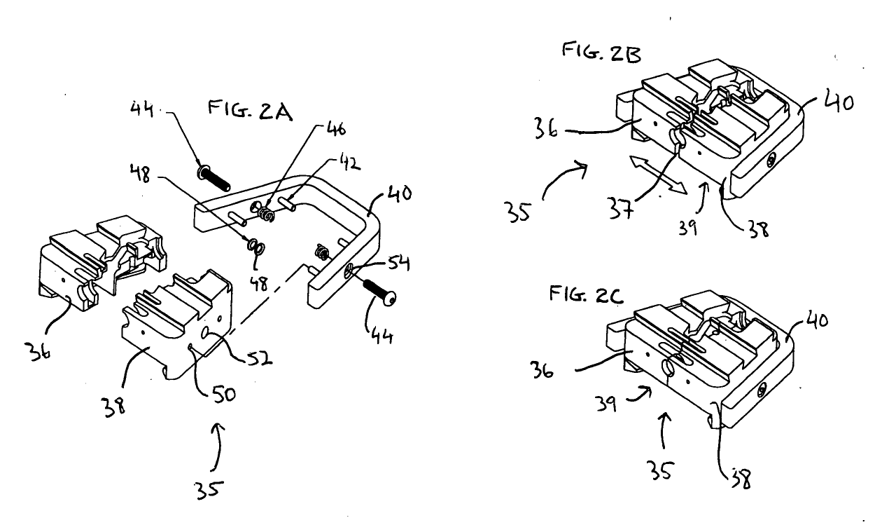

An alternate embodiment of the present invention is shown in FIG. 1C. More specifically, as shown by the broken line in FIG. 1C, a separated side of the socket assembly 10 may be separated from the remainder of the socket assembly not by a vertical plane cutting though the entire assembly, but by a vertical plane extending up from the bottom of the assembly to a point about ⅔ of the way through the assembly and below its top surface and then by a horizontal plane extending out thorough the sidewall of the assembly (along the broken line shown in FIG. 1C). Thus, in this alternative configuration, the top surface of the assembly remains unbroken so it can interact with other parts of the helmet mount, such as along the dovetail rails 18, without any concerns of misalignment between the two pieces of the socket assembly. The lower, separate piece does not affect the top surface and, yet, provides horizontal adjustability for the socket in the bottom surface. This configuration may also be applied to any one of the other embodiments described below with respect to FIGS. 2-5.

In another exemplary embodiment of the present invention, as shown in FIGS. 2A-2C, an adjustable socket assembly 35 includes a first socket portion 36 and a second socket portion 38, the second socket portion being matable with the first socket portion. The adjustable socket assembly 35 also includes a frame 40 adapted to fit around three sides of the adjustable socket assembly 35. The frame 40 includes four rail pins 42 which extend from interior lateral surfaces of the frame. The rail pins 42 are adapted to be inserted into corresponding socket rail pin holes 50, thus allowing the first and second socket portions 36, 38 to be attached to the frame 40. When the first and second socket portions 36, 38 are attached to the frame 40, a dovetail-shaped NVG receiving area 39 is formed. The frame 40 is relatively flexible, allowing a gap 37 to be created between the first portion 36 and the second portion 38 when, for instance, a dovetail insert is slid into the NVG receiving area 39. Thus the NVG receiving area is adjustable to receive variously sized dovetail inserts. In one exemplary embodiment, the frame 40 is flexible enough to allow a gap of about 0.030 inch between the first and second socket portions 36, 38. However, the size of the gap is not limited thereto, and the flexibility of the frame may allow for larger or smaller maximum gap widths. The frame may be made from spring steel, stainless or a nylon material, but the composition of the frame is not limited thereto.

A retaining screw 44 may be inserted through a frame retaining hole 54 and into a socket threaded hole 52 in each respective socket portion 36, 38 to maintain the attachment between each socket portion and the frame 40. A coil spring 46 may be inserted over the retaining screw 44 between a side of each socket portion 36, 38 and the frame 40 or belville washers 48 placed over the retaining screw to pre-load the socket assembly 35, biasing the socket portions away from the frame when a dovetail insert is inserted into the of NVG receiving area 39.

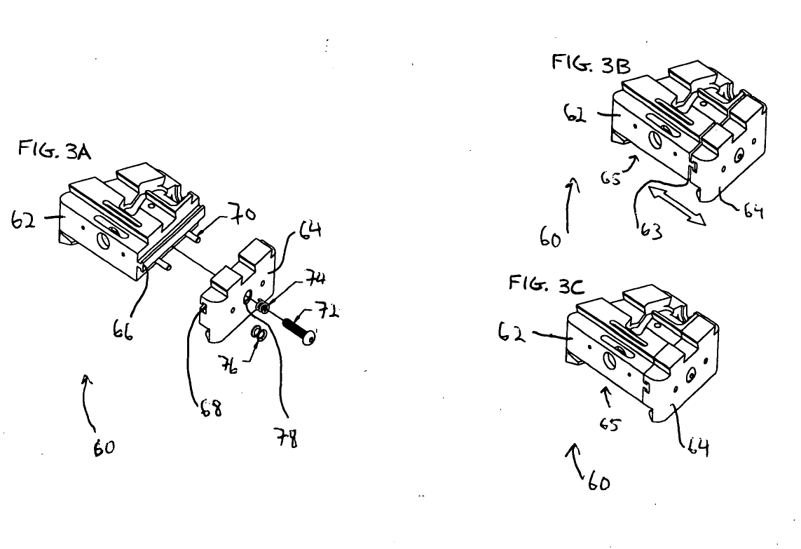

Yet another exemplary embodiment of an adjustable socket assembly 60 of the present invention is shown in FIGS. 3A-3C. Similarly to the adjustable socket assembly 10 described above with respect to FIGS. 1A-1C, the adjustable socket assembly 60 includes a body 62 and a branch 64 matable with the body. However, in this embodiment the body 62 includes a substantially T-shaped rail 66 extending from an interior sidewall. The rail 66 is slidably connectable to a track 68 located on an interior sidewall of the branch 64. The branch slides onto the rail to more securely hold the body and branch together. Guide pins 70 are inserted through the branch after the branch is attached to the body to provide for adjustability. Referring to FIGS. 3B and 3C, the adjustable socket assembly also includes an NVG receiving area 65 as described above.

Referring now to FIG. 3B, when the body 62 and the branch 64 are mated, a dovetail-shaped NVG receiving area 65 is formed. The rail-track system which maintains a connection between the body and the branch may be dimensioned to allow a gap 63 to be created between the body and branch, thus allowing for an adjustable NVG receiving area 65. Specifically, the depth of the track 68 may be designed such that when the rail 66 is inserted along the track, the width of the rail does not occupy the entire space provided by the track, allowing the rail to move laterally within the track and create the gap 63 between the body 62 and the branch 64. The height of the rail 66 and the depth of the track 68 may vary depending on the amount of separability desired between the body 62 and the branch 64. In one exemplary embodiment, the body 62 and the branch 64 are separable by about 0.3 inch but the gap width is not limited thereto. The guide pins 70 located along the same interior sidewall of the body 62 as the rail 66 serve to ensure that the branch 64 will remain aligned with the body when they are separated.

Referring again to FIG. 3A, a retaining screw 72 is insertable through a branch retaining hole 78 and into a body threaded hole (not shown) to maintain a secure connection between the body 62 and the branch 64. As described above, the width of the gap 63 may be determined by the depth to which the retaining screw 72 is threaded into the body threaded hole as well as by the depth of the rail 66 and the track 68. For example, the farther the screw is threaded into the body threaded hole, the narrower the maximum gap 63 between the body 62 and the branch 64, regardless of the depth of the rail 66 or the track 68. Additionally, the retaining screw 72 may be threaded into the body threaded hole such that there is no gap between the body 62 and the branch 64. A coil spring 74 may be inserted between the head of the retaining screw 72 and a side of the branch 64 to pre-load the socket assembly and bias the branch away from the retaining screw head when, for example, a dovetail insert is inserted into the NVG receiving area 65. In an alternate embodiment, belville washers 76 may be placed between the branch side and the head of the retaining screw 72.

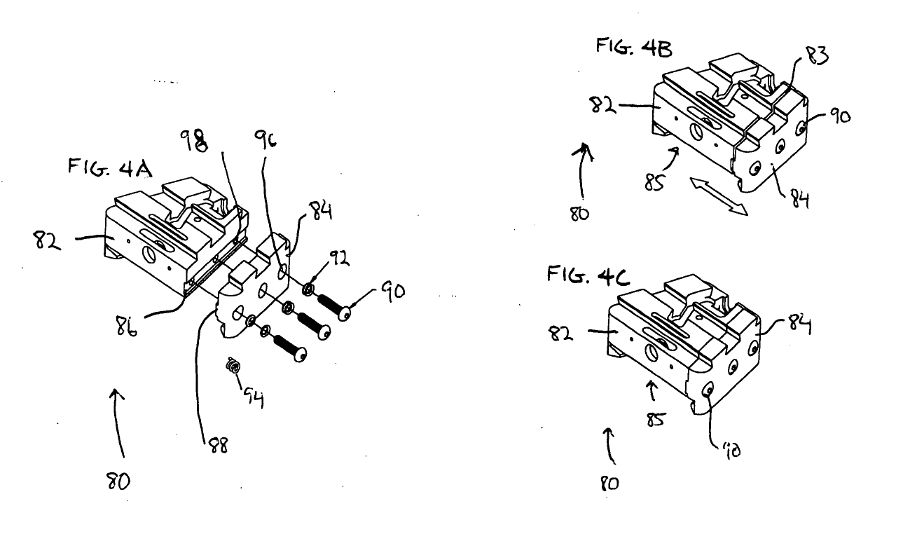

In yet another exemplary embodiment of the present invention as shown in FIGS. 4A-4C, an adjustable socket assembly 80 includes a body 82 and a branch 84 matable with the body, similar to the body and the branch described above with respect to FIGS. 1A-1C. However, in this embodiment the body 82 includes a track 86 adapted to receive a rail 88 on the branch 84. The rail and track maintain alignment between the body and the branch during adjustment movement.

The adjustable socket assembly 80 also includes three retaining screws 90 which serve to attach the branch 84 to the body 82 while allowing a gap 83 to be created between the branch and the body, as shown in FIG. 4B. More specifically, each retaining screw 90 is insertable through a respective branch retaining hole 96 and is threadable into a body threaded hole 98. The amount of separation between the body 82 and the branch 84 is determined by how far the retaining screws 90 are threaded into the body threaded holes 98. The further the retaining screws 90 are threaded into the body threaded holes 98, the less maximum separation between the body 82 and the branch 84. Having three retaining screws 90 increases the likelihood that when all three retaining screws 90 are threaded to the same depth, the branch 84 and the body 82 will remain aligned. Although the present embodiment is described with respect to three retaining screws, the present invention is not limited thereto and the number of retaining screws used may vary.

In one exemplary embodiment, belville washers 92 may be placed between a head of each screw 90 and the body 82 to pre-load the socket assembly. Thus, when a dovetail insert is inserted into the NVG receiving area 85, the socket assembly 80 will securely retain the dovetail insert. In an alternate embodiment, a coil spring 94 may be used to pre-load the socket assembly.

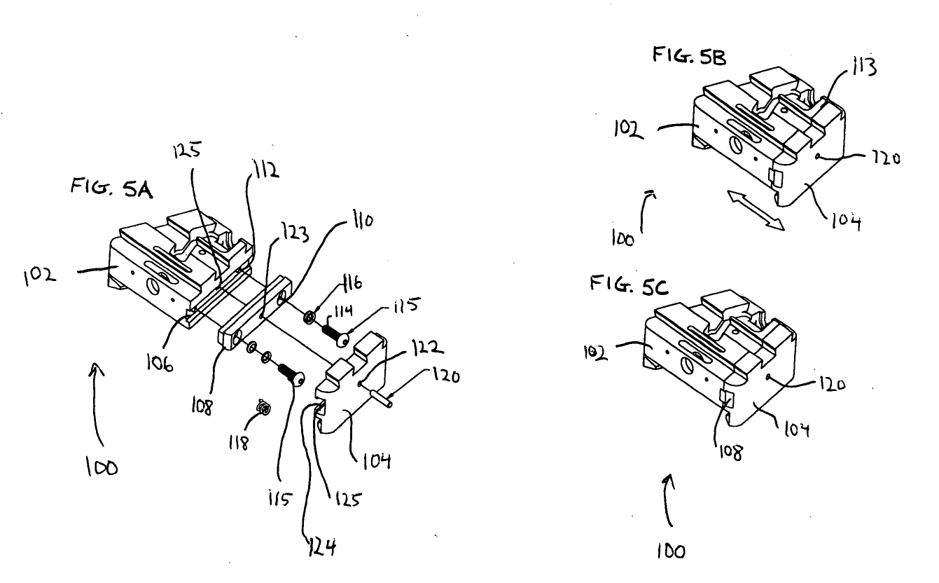

In yet another alternate embodiment of the present invention as shown in FIGS. 5A-5C, an adjustable socket assembly 100 includes a body 102 and a branch 104 matable with the body, similar to the body and the branch described above with respect to FIGS. 4A-4C. In this embodiment, the body 102 includes a track 106 adapted to receive an insert 108, the insert being locatable between the body and the branch 104. The insert is T-shaped with the wider head of the T located outside of track 106. Retaining screws 114 may be inserted through respective insert holes 110 and threaded into threaded body holes 112 to attach the insert 108 to the body. Belville washers 116 may be inserted over the screw threads to pre-load the socket assembly. Alternatively, coil springs 118 may be inserted over the screw threads to pre-load the socket assembly.

The branch 104 includes a recess 124 adapted to receive the wider head of the insert to connect the branch to the body 102. More specifically, to couple the branch 104 to the body 102, the recess 124 may slide over the wider head of the insert 108 such that lips 125 on the recess engage the head. The retaining screws 114 may be threaded to a depth to allow a gap 113 (FIG. 5B) to be created between the branch 104 and the body 102, and more specifically, between the insert 108 and the body. The gap 113 allows the adjustable socket assembly 100 to accommodate different dovetail sizes securely. Although the width of the gap 113 may vary depending on screw depth, in one exemplary embodiment, the maximum width of the gap is about 0.030 inch. A locating pin 120 may be inserted through locating pin holes 122, 123, 125 in the branch, insert and body, respectively. The locating pin serves to ensure that the branch 104 will remain aligned with the body 102 when there is separation between the body and the branch. In the present embodiment, since the branch 104 is inserted over the internal insert 108, the socket assembly has smooth exterior sidewalls.

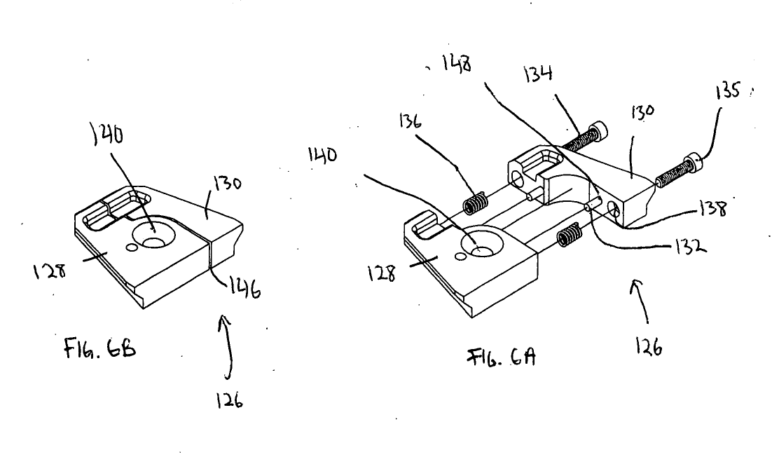

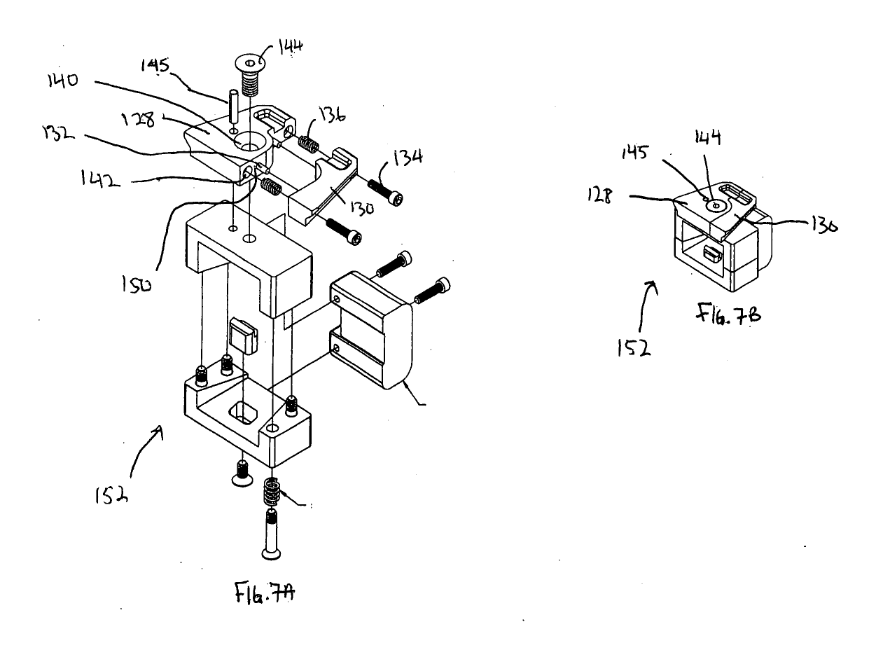

As shown in FIGS. 6A-6B, an exemplary embodiment of an adjustable dovetail insert 126 is shown. The adjustable dovetail insert 126 may be used with a fixed socket assembly or an adjustable socket assembly, such as the adjustable socket assemblies described herein. Providing an adjustable dovetail insert 126 allows the insert to compensate for size differences in NVG receiving areas on various socket assemblies, and for the insert to be securely fixed within such NVG receiving areas. The adjustable dovetail 126 includes a body 128 and a branch 130, the branch being matable with the body. The body 128 and the branch 130 are adapted to be adjustable such that a gap 146 created between adjacent interior sidewalls of the body and the branch may vary when the branch is attached to the body. More specifically, retaining screws 134 are insertable through respective branch retaining holes 138 and into body threaded holes 142 (FIG. 7A) to attach the body 128 to the branch 130. A retaining screw head 135 prevents the branch 130 from completely separating from the body. However, depending on the depth to which the retaining screws 134 are threaded, the branch 130 is slidable along the screws allowing the gap 146 to be created. In one exemplary embodiment, the maximum width of the gap is about 0.030 inch.

Guide pins 132 insertable into guide pin holes 148, 150 on the branch and body, respectively, serve to maintain alignment between the branch and the body separated by the gap 146. A coil spring 136 may be inserted over each retaining screw 134 to bias the branch 130 away from the body 128 and to maintain the gap 146. When the adjustable dovetail insert 126 is inserted into an NVG receiving area, the coil springs 136 allow the insert to conform to the size of the receiving area and maintain a secure fit within the receiving area.

As shown in FIGS. 7A-7B, the adjustable dovetail insert 126 is attachable to a vertically adjustable adaptor 152 for goggle horns. The adjustable dovetail insert 126 includes an attachment hole 140 through which an attachment screw 144 is insertable to secure the adjustable dovetail insert 126 to the adaptor 152. A cylindrical or roll pin 145 may be inserted into a hole 147 extending through the body of the insert and down into a cylindrical recess 149 located in the top surface of the adapter. The hole and recess are offset to one side of the attachment screw and are dimensioned to securely receive pin 145. Once in place, the pin helps prevent rotation of the insert relative to the adaptor. Having the adjustable dovetail insert 126 attached to the adaptor 152 allows NVG having a goggle horn to be attached to a headgear mount adapted to receive a dovetail. As such, the adaptor 152 is adapted for use with a greater number of headgear mounts.

While various embodiments of this invention have been shown and described, it would be apparent to those skilled in the art that many more modifications are possible without departing from the inventive concept herein. It is, therefore, to be understood that within the scope of the appended claims, this invention may be practiced otherwise than as specifically described.

What is claimed is:

1. An adjustable socket assembly adapted to receive a night vision device, the adjustable socket assembly comprising:
a body;
a branch; and
guide means attached to one of the body and the branch;
wherein one of the body and the branch is slidably coupled to the guide means;
wherein the body is aligned with the branch to form a night vision device receiving area having an adjustable width; and
wherein the guide means maintains alignment between the body and the branch.

2. The adjustable socket assembly of claim 1, wherein the guide means are a plurality of guide pins.

3. The adjustable socket assembly of claim 1, wherein the guide means are a plurality of screws.

4. The adjustable socket assembly of claim 1, further comprising a retaining means inserted through one of the body and the branch and attached to the other of the body and the branch;
wherein the retaining means prevent decoupling of one of the body and the branch from the guide means.

5. The adjustable socket assembly of claim 4, wherein the retaining means is a retaining screw.

6. The adjustable socket assembly of claim 1, one of the body and the branch further comprising a rail track; and
the other of the body and the branch further comprising a rail adapted to be coupled with the rail track;
wherein when the rail is coupled with the rail track, the rail prevents one of the body and the branch from decoupling from the guide means.

7. An adjustable socket assembly adapted to receive a night vision device, the adjustable socket assembly comprising:
a flexible frame adapted to expand when a night vision device is coupled to the adjustable socket assembly; and
a branch and a body attached to the frame, the branch and the body aligned to form a width adjustable night vision device receiving area;
wherein the night vision device receiving area is adapted to securely accommodate night vision devices of varying widths.

8. An adjustable socket assembly adapted to receive a night vision device, the adjustable socket assembly comprising:
a body;
a branch; and
a plurality of guide pins attached to one of the body and the branch;
wherein one of the body and the branch is slidably coupled to the plurality of guide pins;
wherein the body is aligned with the branch to form a night vision device receiving area having an adjustable width; and
wherein the plurality of guide pins maintain alignment between the body and the branch.

9. The adjustable socket assembly of claim 8 further comprising a retaining member inserted through one of the body and the branch and attached to the other of the body and the branch, wherein the retaining member prevents decoupling of one of the body and the branch from the plurality of guide pins.

10. The adjustable socket assembly of claim 9, further comprising a coil spring inserted between the retaining member and one of the body and the branch to bias one of the body and the branch toward the other of the body and the branch.

11. An adjustable insert to allow a night vision device to be coupled to a headgear mount, the adjustable insert comprising:
a branch having a first rail;
a body having a second rail; and
guide means attached to one of the body and the branch; and
at least one coil spring inserted between the body and the branch to bias the branch away from the body;
wherein one of the body and the branch is slidably coupled to the guide means.

12. The adjustable insert of claim 11, wherein the guide means is a plurality of guide pins.

13. The adjustable insert of claim 11 further comprising a retaining means inserted through one of the branch and the body and attached to the other of the branch and the body to prevent one of the branch and the body from decoupling from the guide means.

14. The adjustable insert of claim 13, wherein the retaining means is a retaining screw.

15. The adjustable insert of claim 11, wherein the insert is dovetail shaped.

16. The adjustable insert of claim 11, further comprising a height adjustable adaptor for goggle horns attached to the adjustable insert.

17. The adjustable insert of claim 16, wherein the height adjustable adaptor is attached to the adjustable insert by an attachment screw.

18. The adjustable insert of claim 16 further comprising a roll pin inserted into the adjustable insert and the height adjustable adaptor, wherein the roll pin prevents rotation of the adjustable insert with respect the height adjustable adaptor.

19. A horizontally adjustable assembly for attaching night vision goggles to a headgear mount for night vision goggles comprising:
a first member;
a second member;
guide means attached to one of the first member and the second member;
wherein one of the first member and the second member is slidably attached to the guide means; and
wherein the guide means maintain alignment between the first member and the second member.

20. The horizontally adjustable assembly of claim 19, wherein the guide means is a plurality of guide pins.
